(19) United States
(12) Patent Application Publication
(10) Pub. No.: US 2016/0029683 A1
(43) Pub. Date: Feb. 4, 2016

(54) LOW CALORIE INFANT FORMULA CONTAINING BETA-HYDROXY-BETA-METHYLBUTYRIC ACID

(71) Applicant: ABBOTT LABORATORIES, Abbott Park, IL (US)

(72) Inventors: Steven Davis, Galena, OH (US); Barbara Marriage, Columbus, OH (US); Christine Gallardo, New Albany, OH (US); Marti Bergana, Blacklick, OH (US)

(73) Assignee: ABBOTT LABORATORIES, Abbott Park, IL (US)

(21) Appl. No.: 14/777,206

(22) PCT Filed: Mar. 14, 2014
(86) PCT No.: PCT/US14/28254

§ 371 Date: Sep. 15, 2015

Related U.S. Application Data
(60) Provisional application No. 61/791,782, filed on Mar. 15, 2013.

(51) Int. Cl. A23L 1/305; A23L 1/29

(52) U.S. Cl. CPC A23L 1/3051; A23L 1/296; A23V 2002/00

(57) ABSTRACT

Low calorie nutritional compositions comprising beta-hydroxy-beta-methylbutyric acid which may support accretion of lean body mass and development of a healthy body composition in term infants are provided. The low calorie nutritional compositions may be liquid or powder infant formulas.

### CROSS REFERENCE TO RELATED APPLICATIONS

This application claims priority to and the benefit of U.S. Provisional Application No. 61/791,782, filed Mar. 15, 2013, the entire content of which is incorporated herein by reference.

### FIELD

The present disclosure relates to low calorie nutritional compositions comprising beta-hydroxy-beta-methylbutyric acid and methods for promoting protein synthesis, accretion of lean body mass, and development of a healthy body composition in term infants. The low calorie nutritional compositions may be solid, semisolid, powder, or liquid infant formulas.

### BACKGROUND

Infants that consume infant formula tend to accumulate more mass, particularly body fat, at a faster rate than infants fed breast milk. Recent studies support the hypothesis that rapid weight gain in infancy influences or programs the infant to have a greater risk of long-term obesity, insulin resistance, and cardiovascular disease. One potential explanation for the difference in weight gain is that formula-fed infants typically have a higher macronutrient intake than breast-fed infants.

Ideally, the energy content of infant formula should be equivalent to the corresponding energy content of human milk at the different stages of lactation. However, commercial infant formula is typically designed to be appropriate for feeding an infant during the entire first year of life. Consequently, many commercially available infant formulas have energy densities as high as 670 kcal/L, which is far greater than the energy content of early breast milk.

### SUMMARY

The present disclosure relates to term infant formulas that are closer to breast milk with respect to composition and function. Thus, term infant formulas according to the present disclosure provide an infant with healthier body composition, i.e., a more desirable muscle mass to fat mass ratio. The present formulas comprise beta-hydroxy-beta-methylbutyric acid (HMB), which Applicants have surprisingly found to promote protein synthesis in the term infant, without attenuating protein degradation in the infant's muscles and organs that may be required for healthy development. Applicants' findings are particularly surprising given that it is well established that HMB attenuates protein degradation in the muscles of adults.

Without wishing to be bound by theory, it is believed that the term infant formulas increase lean body mass by increasing protein synthesis without inhibiting protein degradation in the muscle and other organs of an infant. It is believed that term infant formulas comprising HMB will promote accretion of lean body mass and a healthier body composition without requiring higher protein intakes.

It has further been surprisingly discovered that the use of HMB in infant formulas instead of leucine to promote protein synthesis provides several advantages. First, HMB provides similar if not superior potency for stimulating protein synthesis than leucine. Second, HMB promotes protein synthesis without increasing blood urea nitrogen, which can be an issue for certain infants.

Thus, the present disclosure is directed to an infant formula comprising HMB at from about 60 μg to about 6,000 mg per liter of the composition and a macronutrient, wherein the formula has an energy density of from about 200 to about 650 kcal per liter. The formula may be administered in any suitable way, for example, orally or via naso-gastric and other modes of tube-feeding.

The present disclosure is also directed to a method for promoting protein synthesis, accretion of lean body mass, and development of a healthy body composition in a term infant, the method comprising the step of administering to the infant a composition comprising HMB at from about 60 μg to about 6,000 mg per liter of the composition, wherein the composition has an energy density of from about 200 to about 650 kcal per liter.

### BRIEF DESCRIPTION OF THE FIGURES

FIG. 1 shows a plot of the blood plasma concentration of HMB vs. the amount of HMB infused in piglets.

FIG. 2 shows a plot of plasma concentrations of various compounds vs. the amount of HMB infused in piglets.

FIG. 3 is a plot of amino acid concentration vs. plasma BCAA, EAA, NEAA and leucine concentrations in piglets infused with HMB or leucine.

FIG. 4 shows a plot of plasma glucose concentrations in piglets infused with HMB.

FIG. 5 shows a plot of the fractional rate of protein synthesis in skeletal muscles of piglets infused with HMB.

FIG. 6 shows a plot of the fractional protein synthesis in the lung of piglets infused with HMB.

FIG. 7 shows a plot of the fractional protein synthesis in the spleen of piglets infused with HMB.

FIG. 8 shows the protein synthesis rate in various muscles of piglets in response to infusion of HMB or leucine.

FIG. 9 shows a plot of the phosphorylation of S6K1 in muscles of piglets infused with HMB.

FIG. 10 shows a plot of the phosphorylation of 4EBP1 in muscles of piglets infused with HMB.

FIG. 11 shows a plot of the formation of the active elF4E•elF4G complex in muscles of piglets infused with HMB.

FIG. 12 shows a plot of the phosphorylation of elF2α in muscles of piglets infused with HMB.

FIG. 13 shows a plot of the phosphorylation of eEF2 in muscles of piglets infused with HMB.

FIG. 14 shows a plot of the expression of Atrogin-1 in muscles of piglets infused with HMB.

FIG. 15 shows a plot of the expression of MURF1 in muscles of piglets infused with HMB.

FIG. 16 shows a plot of the ratio of LC3-II/LC3-I in muscles of piglets infused with HMB.

### DETAILED DESCRIPTION

The infant formulas and related methods as described herein may promote protein synthesis and accretion of lean body mass in the term infant with minimal if any interference with the protein degradation in the infant's muscles and organs that may be required for healthy development. The elements or features of the various embodiments are described in detail hereinafter.

“Lean body mass” as used herein means the total mass of muscle that is present in the body.

“Term infant” as used herein means an infant born at or beyond the thirty-seventh completed week of gestation.

“Low calorie” as used herein means an energy density of from about 200 to about 650 kcal, per liter of formula.

“Free” or “substantially free” as used herein means the selected composition or method contains or is directed to less than a functional amount of the ingredient or feature, typically less than 0.1% by weight, and also including zero percent by weight, of such ingredient or feature. The nutritional compositions and methods herein may also be “free of” or “substantially free of” any optional or other ingredient or feature described herein provided that the remaining composition still contains the requisite ingredients or features as described herein.

The terms “fat,” “oil” and “lipid” as used herein, unless otherwise specified, are used interchangeably to refer to lipid materials derived or processed from plants or animals. These terms also include synthetic lipid materials so long as such synthetic materials are suitable for oral administration to humans.

The terms “infant formula,” “nutritional product,” and “nutritional composition,” are used interchangeably herein and, unless otherwise specified, refer to nutritional solids, nutritional liquids, nutritional semi-liquids, nutritional semi-solids, and nutritional powders. The nutritional powders may be reconstituted to form a nutritional liquid, all of which comprise at least one macronutrient, which may be selected from the group consisting of fat, protein and carbohydrate and which are suitable for oral consumption by an infant.

“Nutritional liquid,” as used herein, unless otherwise specified, refers to nutritional compositions in ready-to-drink liquid form, concentrated form, and nutritional liquids made by reconstituting the nutritional powders described herein prior to use.

“Nutritional powder,” as used herein, unless otherwise specified, refers to nutritional compositions in flowable or scoopable form that can be reconstituted with water or another aqueous liquid prior to consumption and includes both spray dried and drymixed/dryblended powders.

The term “infant formula” as used herein refers to nutritional compositions that are designed specifically for consumption by an infant.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified. All numerical ranges as used herein, whether or not expressly preceded by the term “about,” are intended and understood to be preceded by that term, unless otherwise specified.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

Any reference to a singular characteristic or limitation of the present disclosure shall include the corresponding plural characteristic or limitation, and vice versa, unless otherwise specified or clearly implied to the contrary by the context in which the reference is made.

Any combination of method or process steps as used herein may be performed in any order, unless otherwise specifically or clearly implied to the contrary by the context in which the referenced combination is made.

The infant formulas and methods may comprise, consist of, or consist essentially of the elements and features of the disclosure described herein, as well as any additional or optional ingredients, components, or features described herein or otherwise useful in an infant nutritional application.

All documents (patents, patent applications and other publications) cited in this application are incorporated herein by reference in their entirety.

### Product Form

The infant formulas of the present disclosure comprise HMB and are capable of promoting protein synthesis and accretion of lean body mass in term infants. The infant formulas may be formulated and administered in any suitable oral product form. Any solid, semisolid, liquid, semi-liquid, or powder form, including combinations or variations thereof, are suitable for use herein, provided that such forms allow for safe and effective oral delivery to an infant of the ingredients as defined herein.

The infant formulas of the present disclosure include any product form comprising the ingredients described herein, and which is safe and effective for oral administration to an infant. The infant formulas may be formulated to include only the ingredients described herein, or may be modified with optional ingredients to form a number of different product forms. The infant formulas of the present disclosure are preferably formulated as dietary product forms, which are defined herein as those embodiments comprising the ingredients of the present disclosure in a product form that further comprises at least one macronutrient. Non-limiting examples of useful macronutrients include fat, protein, carbohydrate and combinations thereof. Micronutrients may also be present in the infant formulas. Non-limiting examples of micronutrients include vitamins, minerals, and combinations thereof.

The infant formulas of the present disclosure may be formulated as milk-based liquids, soy-based liquids, amino acid-based liquids, low-pH liquids, clear liquids, and reconstitutable powders.

The infant formulas of the present disclosure are formulated to be low calorie formulas. In other words, the infant formulas of the present disclosure are formulated with one or more macronutrients such that the infant formulas have an energy density of from about 200 to about 650 kcal per liter of formula. In certain embodiments, the infant formulas have an energy density of from about 200 to about 600 kcal per liter of formula, from about 250 to about 550 kcal per liter of formula, from about 300 to about 500 kcal per liter of formula, or from about 350 to about 450 kcal per liter of formula.

### Beta-Hydroxy-Beta-Methylbutyric Acid (HMB)

The infant formulas of the present disclosure comprise HMB, which means that the infant formulas are either formulated with the addition of HMB, most typically as the monohydrate calcium salt of HMB, or are otherwise prepared so as to contain HMB in the finished product.

Any source of HMB is suitable for use herein provided that the finished product contains HMB, although in some embodiments, the source is preferably calcium HMB and is most typically added as such to the infant formulas during formulation. Other suitable sources may include HMB as the free acid, a salt, an anhydrous salt, an ester, a lactone, or other product forms that otherwise provide a bioavailable form of HMB. Non-limiting examples of suitable salts of HMB for use herein include HMB salts, hydrated or anhydrous, of sodium, potassium, magnesium, chromium, calcium, or other non-toxic salt form and combinations thereof. In certain embodiments, the infant formula comprises HMB in a form selected from the free acid, a salt, an anhydrous salt, an ester, a lactone, and mixtures thereof. In certain embodiments, the HMB in the infant formula is a salt of HMB selected from a calcium salt, a sodium salt, a potassium salt, a magnesium salt, a chromium salt, and mixtures thereof. Calcium HMB monohydrate is commercially available from Technical Sourcing International (TSI) of Salt Lake City, Utah and from Lonza Group Ltd. (Basel, Switzerland).

The infant formulas as described herein may comprise an amount of HMB that is sufficient and effective to promote healthy body composition through accretion of lean body mass, for example, by increasing protein synthesis.

In certain embodiments, the infant formula is formulated as a liquid. When the infant formula is a liquid, the concentration of HMB in the liquid may be by weight of the liquid infant formula. In certain embodiments, the infant formula comprises HMB at from about 60 μg to about 6,000 mg per liter of the infant formula. In some embodiments, the HMB may be present in either a ready-to-feed liquid infant formula or a liquid made by reconstituting a powder infant formula (i.e., a reconstitutable powder infant formula) of the present invention, in an amount greater than about 60 μg, less than about 6,000 mg, less than about 4,800 mg, less than about 1,500 mg, less than about 300 mg, from about 60 ₗug to about 6,000 mg, from about 60 ₗug to about 4,800 mg, from about 60 μg to about 1,500 mg, or from about 60 μg to about 300 mg per liter of the infant formula.

In certain embodiments, the infant formula is formulated as a powder. When the infant formula is a powder, the concentration of HMB in the powder may be less than or equal to about 15%, including from about 0.0001% to about 15%, from about 0.1% to about 10%, from about 0.1% to about 2%, and also including from about 0.2% to about 5%, from about 0.3% to about 3%, and also including from about 0.34% to about 1.5%, by weight of the powder. In some embodiments, when the infant formula is a powder, the HMB is present in the powder in an amount of from about 0.1% to about 0.5% by weight of the powder.

The concentration of HMB in a liquid infant formula, including the liquid derived from reconstituting a powder infant formula, may be measured using the method described in: Baxter, Jeffrey H. (2001). Direct Determination of β-Hydroxy-β-Methylbutyrate (HMB) in Liquid Nutritional Products. Food Anal. Methods, Vol. 4, 341-346.

### Macronutrients

The infant formulas of the present disclosure comprise one or more macronutrients in addition to the HMB described herein. The macronutrient may include proteins, fats, carbohydrates, and combinations thereof. In certain embodiments, the infant formulas comprise a protein. In certain embodiments, the infant formulas comprise a carbohydrate. In certain embodiments, the infant formulas comprise a fat. In certain embodiments, the infant formulas comprise one or more of a protein, a carbohydrate, and a fat. In certain embodiments, the infant formulas may be formulated as dietary products containing all three macronutrients.

Macronutrients suitable for use herein may include any protein, fat, or carbohydrate or source thereof that is known for or otherwise suitable for use in an oral nutritional composition, provided that the optional macronutrient is safe and effective for oral administration and is otherwise compatible with the other ingredients in the nutritional composition.

The concentration or amount of fat, carbohydrate, and/or protein in the infant formulas described herein may vary considerably depending upon the particular product form (e.g., milk or soy based liquids, amino acid-based liquids or other clear beverages, reconstitutable powders) and the various other formulations and targeted dietary needs of the intended user. Such concentrations or amounts of macronutrients most typically fall within one of the embodied ranges described in Table I, wherein each numerical value is to be considered as preceded by the term “about”, inclusive of any other essential fat, protein, and or carbohydrate ingredients as described herein. Note that in relation to powder embodiments, the amounts in the following tables are amounts following reconstitution of the powder.

TABLE I

| Nutrient | | |
|---|---|---|
| (g nutrient/100 mL | | |
| of formula) | Example A | Example B |
| Protein | 0.5 to 1.5 | 0.6 to 0.9 |
| Fat | 1.2 to 3.5 | 1.4 to 2.3 |
| Carbohydrate | 2.7 to 7.5 | 3.1 to 6.1 |

The level or amount of carbohydrate, fat, and protein in the infant formula (whether a powder formula or a liquid ready-to-feed or concentrated liquid) may also be characterized in addition to or in the alternative as a percentage of total calories in the infant formulas. These macronutrients for infant formulas of the present disclosure are most typically formulated within any of the caloric ranges described in Table II (each numerical value should be considered to be preceded by the term “about”).

TABLE II

| Nutrient | | | | | | |
|---|---|---|---|---|---|---|
| (% total calories) | Example A | Example B | Example C | Example D | Example E | Example F |
| Carbohydrate | 2 to 96 | 10 to 75 | 30 to 50 | 25 to 50 | 25 to 50 | 25 to 50 |
| Fat | 2 to 96 | 20 to 85 | 35 to 55 | 1 to 20 | 2 to 20 | 30 to 55 |
| Protein | 2 to 96 | 5 to 70 | 15 to 35 | 10 to 30 | 15 to 30 | 7.5 to 25 |

### Carbohydrate

The infant formulas of the present disclosure may comprise any carbohydrates that are suitable for use in an oral nutritional product, and that are compatible with the elements and features of such a product, provided that such carbohydrates are suitable for feeding to infants.

Carbohydrates suitable for use in the infant formulas may be simple, complex, or variations or combinations thereof, all of which may be in addition to the HMB as described herein. Non-limiting examples of suitable carbohydrates include hydrolyzed or modified starch or cornstarch, maltodextrin, isomaltulose, sucromalt, glucose polymers, sucrose, corn syrup, corn syrup solids, rice-derived carbohydrate, glucose, fructose, lactose, honey, sugar alcohols (e.g., maltitol, erythritol, sorbitol), and combinations thereof.

Carbohydrates suitable for use herein may include soluble dietary fiber, non-limiting examples of which include gum Arabic, fructooligosaccharide (FOS), galactooligosaccharides (GOS), human milk oligosaccharides, sodium carboxymethyl cellulose, guar gum, citrus pectin, low and high methoxy pectin, oat and barley glucans, carrageenan, psyllium, and combinations thereof. Insoluble dietary fiber may also be suitable as a carbohydrate source herein, non-limiting examples of which include oat hull fiber, pea hull fiber, soy hull fiber, soy cotyledon fiber, sugar beet fiber, cellulose, corn bran, and combinations thereof.

### Fat

The infant formulas of the present disclosure may comprise a source or sources of fat. Suitable sources of fat for use in the infant formulas disclosed herein include any fat or fat source that is suitable for use in an oral nutritional product and that is compatible with the essential elements and features of such products, provided that such fats are suitable for feeding to infants.

Non-limiting examples of fats suitable for use in the infant formulas include coconut oil, fractionated coconut oil, soy oil, corn oil, olive oil, safflower oil, high oleic safflower oil, high GLA-safflower oil, medium chain triglycerides (MCT) oil, sunflower oil, high oleic sunflower oil, palm and palm kernel oils, palm olein, canola oil, marine oils, flaxseed oil, borage oil, cottonseed oils, evening primrose oil, blackcurrant seed oil, transgenic oil sources, fungal oils, marine oils (e.g., tuna, sardine), and so forth. In some embodiments, the fats may include monoglycerides, diglycerides, fatty acids, and combinations thereof.

The infant formulas of the present disclosure may optionally comprise a flaxseed component, non-limiting examples of which include ground flaxseed and flaxseed oil. Ground flaxseed is generally preferred. Non- limiting examples of flaxseed include red flaxseed, golden flaxseed, and combinations thereof. Golden flaxseed is generally preferred. Commercial sources of flaxseed are well known in the nutrition and formulation arts, some non-limiting examples of which include flaxseed and flax products available from the Flax Council of Canada, the Flax Consortium of Canada, and Heintzman Farms (North Dakota) (Dakota Flax Gold brand).

### Protein

The infant formulas of the present disclosure may comprise protein. Any known or otherwise suitable protein or protein source may be included in the infant formulas of the present disclosure, provided that such proteins are suitable for feeding to infants, and in particular, newborn infants.

Non-limiting examples of proteins suitable for use in the infant formulas may include hydrolyzed, partially hydrolyzed or non-hydrolyzed proteins or protein sources, and can be derived from any known or otherwise suitable source such as milk (e.g., casein, whey), animal (e.g., meat, fish, egg albumen), cereal (e.g., rice, corn), vegetable (e.g., soy, pea, potato), or combinations thereof. The proteins for use herein may also include, or be entirely or partially replaced by, free amino acids known for use in nutritional products, non-limiting examples of which include L-leucine, L-tryptophan, L-glutamine, L-tyrosine, L-methionine, L-cysteine, taurine, L-arginine, L-carnitine, and combinations thereof.

In some embodiments, the infant formulas of the present disclosure include reduced amounts of protein as compared to conventional term and preterm infant formulas. For example, the reduced protein infant formulas include protein in an amount of less than 14 grams of protein per liter of formula, including from about 0.5 to about 14 grams, from about 5 to about 10 grams, or from about 7.6 to about 10 grams, of protein per liter of formula.

### Optional Ingredients

The infant formulas of the present disclosure may further comprise optional components that may modify the physical, chemical, aesthetic or processing characteristics of the formulas or serve as pharmaceutical or additional nutritional components when used in the targeted population. Many such optional ingredients are known or otherwise suitable for use in nutritional compositions or pharmaceutical dosage forms and may also be used in the infant formulas herein, provided that such optional ingredients are safe and effective for oral administration and are compatible with the other selected ingredients in the composition.

Non-limiting examples of such other optional ingredients include preservatives, anti-oxidants, buffers, additional pharmaceutical actives, sweeteners including artificial sweeteners (e.g., saccharine, aspartame, acesulfame K, sucralose), natural sweeteners (e.g., stevia, monk fruit), colorants, flavors, branch chain amino acids, essential amino acids, free amino acids, flavor enhancers, thickening agents and stabilizers, emulsifying agents, lubricants, and so forth.

The infant formulas of the present disclosure preferably comprise one or more minerals, non-limiting examples of which include phosphorus, sodium, chloride, magnesium, manganese, iron, copper, zinc, iodine calcium, potassium, chromium (e.g., chromium picolinate), molybdenum, selenium, and combinations thereof.

The infant formulas also desirably comprise one or more vitamins, non-limiting examples of which include carotenoids (e.g., beta-carotene, zeaxanthin, lutein, lycopene), biotin, choline, inositol, folic acid, pantothenic acid, choline, vitamin A, thiamine (vitamin B1), riboflavin (vitamin B2), niacin (vitamin B3), pyridoxine (vitamin B6), cyanocobalamine (vitamin B12), ascorbic acid (vitamin C), vitamin D, vitamin E, vitamin K, and various salts, esters or other derivatives thereof, and combinations thereof. In some preferred embodiments, the infant formulas of the present disclosure comprise both vitamins and minerals.

The nutrition compositions may also desirably comprise probiotics, prebiotics and their related derivatives.

### Methods of Using the HMB-Containing Infant Formulas

The infant formulas including HMB as described herein can be used in various methods as set forth herein for term infants. These methods include, but are not limited to, the oral, parenteral, naso-gastric, gastrostomy or jejunostomy administration of the beta-hydroxy-beta-methylbutyric acid-containing infant formulas to an infant to promote protein synthesis and accretion of lean body mass without attenuating protein degradation.

In one embodiment, a method for promoting protein synthesis, accretion of lean body mass, or both in a term infant is provided. The method comprises administering to the infant a liquid infant formula comprising HMB at from about 60 μg to about 6,000 mg per liter of the formula, the formula having an energy density of from about 200 to about 650 kcal per liter. In certain embodiments, the liquid infant formula is prepared by reconstituting a nutritional powder comprising HMB. In certain embodiments, the concentration of HMB in the nutritional powder is less than or equal to about 15% by weight of the powder. In certain embodiments, the concentration of HMB in the nutritional powder is from about 0.0001% to about 10% by weight of the powder. In certain embodiments, the liquid infant formula comprises at least one macronutrient selected from the group consisting of protein, carbohydrate, fat, and combinations thereof. In certain embodiments, the nutritional powder comprising HMB comprises at least one macronutrient selected from the group consisting of protein, carbohydrate, fat, and combinations thereof.

The infant desirably consumes at least one serving of the infant formula daily, and in some embodiments, may consume two, three, or even more servings per day. Each serving is desirably administered as a single, undivided dose, although the serving may also be divided into two or more partial or divided servings to be taken at two or more times during the day. The methods of the present disclosure include continuous day after day administration, as well as periodic or limited administration, although continuous day after day administration is generally desirable. The methods of the present disclosure are preferably applied on a daily basis, wherein the daily administration is maintained continuously for at least 3 days, including at least 5 days, including at least 1 month, including at least 6 weeks, including at least 8 weeks, including at least 2 months, including at least 6 months, desirably for at least 18-24 months, and desirably as a long term, continuous, daily, dietary supplement.

### Method of Manufacture

The infant formulas of the present disclosure may be prepared by any known or otherwise effective manufacturing technique for preparing the selected product form. Many such techniques are known for any given product form such as nutritional liquids or nutritional powders, and can easily be applied by one of ordinary skill in the nutrition and formulation arts to the nutritional products described herein.

Liquid, milk or soy-based nutritional liquids, for example, may be prepared by first forming an oil and fiber blend containing all formulation oils, any emulsifier, fiber and fat-soluble vitamins. Additional slurries (typically a carbohydrate and two protein slurries) are prepared separately by mixing the HMB, carbohydrate and minerals together and the protein in water. The slurries are then mixed together with the oil blend. The resulting mixture is homogenized, heat processed, standardized with any water-soluble vitamins, flavored and the liquid terminally sterilized or aseptically filled or dried, such as by spray drying, to produce a powder.

The solid nutritional embodiments of the present disclosure may also be manufactured through a baked application or heated extrusion to produce solid product forms such as cereals, cookies, crackers, and similar other product forms. One knowledgeable in the nutrition manufacturing arts is able to select one of the many known or otherwise available manufacturing processes to produce the desired final product.

The compositions of the present disclosure may also be manufactured by other known or otherwise suitable techniques not specifically described herein without departing from the spirit and scope of the present disclosure. The present embodiments are, therefore, to be considered in all respects as illustrative and not restrictive and that all changes and equivalents also come within the description of the present disclosure. The following non-limiting examples further illustrate the compositions and methods of the present disclosure.

### EXAMPLES

The following Examples provide data and/or illustrate specific embodiments and/or features of the nutritional compositions and methods of the present disclosure. The Examples are given solely for the purpose of illustration and are not to be construed as limitations, as many variations thereof are possible without departing from the spirit and scope of the disclosure.

### Examples

The following tables describe four exemplary compositions according to the present disclosure, wherein the compositions have differing caloric densities and amounts of HMB.

Example 1, which is found in Table III, is a powdered term infant formula that is useful for feeding a newborn from 0 to 365 days of life. The reconstituted powdered infant formula has a caloric density of 643 Kcal//L and contains 2 mg of HMB per liter of formula. The reconstitution rate is 126.1 grams of powder per liter.

TABLE III

| | Amount per | |
|---|---|---|
| | 1000 Kg batch | |
| Ingredient Name | of Powder | Kg/g/mg |
| Nonfat Milk | 692.9 | kg |
| Lactose | 385.7 | kg |
| High Oleic Safflower Oil | 115.5 | kg |
| Soy Oil | 87.65 | kg |
| Coconut Oil | 80.00 | kg |
| Galacto-oligosaccharides | 70.50 | kg |
| Whey Protein Concentrate | 52.02 | kg |
| Potassium Citrate | 10.95 | kg |
| Calcium Carbonate | 3.55 | kg |
| ARASCO Mortierella alpina Oil | 2.91 | kg |
| Nucleotide-Choline Premix | 2.51 | kg |
| Choline Bitartrate | 443.7 | g |
| Cytidine 5′-Monophosphate | 261.5 | g |
| Disodium Guanosine 5′-Monophosphate | 134.1 | g |
| Disodium Uridine 5′-Monosphosphate | 112.8 | g |
| Adenosine 5′-Monophosphate | 99.4 | g |
| Sodium Chloride | 1.48 | kg |
| Ascorbic Acid | 1.34 | kg |
| Tricalcium Phosphate | 1.25 | kg |
| Vit/Min/Taurine Premix | 1.17 | kg |
| Taurine | 357.5 | g |
| m-Inositol | 259.5 | g |
| Zinc Sulfate | 119.7 | g |
| Niacinamide | 76.3 | g |
| Calcium Pantothenate | 45.7 | g |
| Ferrous Sulfate | 40.0 | g |
| Cupric Sulfate | 14.0 | g |
| Thiamine Chloride HCl | 11.8 | g |
| Riboflavin | 5.22 | g |
| Pyridoxine HCl | 4.78 | g |
| Folic Acid | 1.61 | g |
| Manganese Sulfate | 1.36 | g |
| Biotin | 462 | mg |
| Sodium Selenate | 277 | mg |
| Cyanocobalamin | 36.8 | mg |
| Soy Lecithin | 1.12 | kg |
| Magnesium Chloride | 1.10 | kg |
| Potassium Phosphate Monobasic | 1.09 | |
| DHASCO Crypthecodinium cohnii Oil | 1.09 | kg |
| Ascorbyl Palmitate | 547.6 | g |
| Vitamin A, D3, E, K1 | 543.0 | g |
| RRR Alpha-Tocopheryl Acetate | 76.1 | g |
| Vitamin A Palmitate | 14.5 | g |
| Vitamin K1 (Phylloquinone) | 841.7 | mg |
| Vitamin D3 | 112.3 | mg |
| Ferrous Sulfate | 494.9 | g |
| Carotenoid Premix | 475.1 | g |
| Lutein | 997.7 | mg |
| Lycopene | 997.7 | mg |
| Beta-Carotene | 216.2 | mg |
| Choline Chloride | 452.6 | g |
| Mixed Tocopherols (Tenox GT-2 - 70%) | 241.8 | g |
| Mixed Tocopherols | 169.3 | g |
| Potassium Chloride | 207.0 | g |
| L-Carnitine | 27.6 | g |
| Calcium HMB | 20.4 | g |
| Riboflavin | 3.33 | g |
| Potassium Hydroxide (processing aid) | as needed | |

Example 2, which is found in Table IV, is a ready-to-feed liquid term infant formula that is useful for feeding a newborn from days 1 to 2 of life. The infant formula has a caloric density of 270 kcal/L and contains 0.3 mg of HMB per liter of formula.

TABLE IV

| | Amount per 1000 Kg of | |
|---|---|---|
| | Ready-to-Feed Liquid | |
| Ingredients | Formula | Units |
| Ingredient Water | Q.S. | kg |
| Lactose | 22.5 | kg |
| Nonfat Dry Milk | 11.0 | kg |
| High Oleic Safflower Oil | 5.49 | kg |
| Galactooligosaccharides | 4.40 | kg |
| Soy Oil | 4.11 | kg |
| Coconut Oil | 3.92 | kg |
| Whey Protein Concentrate | 2.70 | kg |
| 1N KOH | 1.06 | kg |
| Potassium Hydroxide | 53.0 | g |
| Ascorbic Acid | 485.0 | g |
| ARASCO Mortierella alpina Oil | 363.0 | g |
| Nucleotide-Choline Premix | 328.5 | g |
| Choline Bitartrate | 57.98 | g |
| Cytidine 5′-Monophosphate | 34.16 | g |
| Disodium Guanosine 5′-Monophosphate | 17.52 | g |
| Disodium Uridine 5′-Monophosphate | 14.73 | g |
| Adenosine 5′-Monophosphate | 12.99 | g |
| Calcium Citrate | 182.3 | g |
| Soy Lecithin | 143.0 | g |
| Distilled Monoglycerides | 143.0 | g |
| DHASCO Crypthecodinium cohnii Oil | 138.2 | g |
| Ultra Micronized Tricalcium Phosphate | 104.2 | g |
| Carrageenan | 100.0 | g |
| Carrageenan | 100.0 | g |
| Magnesium Chloride | 93.8 | g |
| Vit/Min/Taur Premix | 66.1 | g |
| Taurine | 20.21 | g |
| m-Inositol | 14.67 | g |
| Zinc Sulfate | 6.77 | g |
| Niacinamide | 4.31 | g |
| Calcium Pantothenate | 2.59 | g |
| Ferrous Sulfate | 2.26 | g |
| Cupric Sulfate | 793.7 | mg |
| Thiamine Chloride HCl | 669.3 | mg |
| Riboflavin | 295.1 | mg |
| Pyridoxine HCl | 270.4 | mg |
| Folic Acid | 90.9 | mg |
| Manganese Sulfate | 77.0 | mg |
| Biotin | 26.1 | mg |
| Sodium Selenate | 15.7 | mg |
| Cyanocobalamin | 2.08 | mg |
| Mixed Carotenoid Premix | 58.1 | g |
| Lycopene | 121.2 | mg |
| Lutein | 121.2 | mg |
| Beta-Carotene | 26.3 | mg |
| Potassium Chloride | 27.1 | g |
| Ferrous Sulfate | 26.9 | g |
| Vitamin A, D3, E, K1 | 22.5 | g |
| RRR Alpha-Tocopheryl Acetate | 4.53 | g |
| Vitamin A Palmitate | 851.4 | mg |
| Vitamin K1 (Phylloquinone) | 49.3 | mg |
| Vitamin D3 | 5.97 | mg |
| Choline Chloride | 21.5 | g |
| Sodium Chloride | 15.3 | g |
| L-Carnitine | 1.87 | g |
| Potassium Citrate | 1.24 | g |
| Riboflavin | 386 | mg |
| Calcium HMB | 384 | mg |
| Vitamin A Palmitate | 310 | mg |
| Thiamine Hydrochloride | 220 | mg |

Example 3, which is found in Table V, is a ready-to-feed liquid term infant formula that is useful for feeding a newborn from days 3 to 9 of life. The infant formula has a caloric density of 406 kcal/L and contains 25 mg of HMB per liter of formula.

TABLE V

| | Amount per 1000 Kg of | |
|---|---|---|
| | Ready to Feed Liquid | |
| Ingredients | Formula | Units |
| Ingredient Water | Q.S. | kg |
| Lactose | 36.1 | kg |
| Nonfat Dry Milk | 15.9 | kg |
| Galactooligosaccharides | 8.63 | kg |
| High Oleic Safflower Oil | 7.63 | kg |
| Soy Oil | 5.72 | kg |
| Coconut Oil | 5.45 | kg |
| Whey Protein Concentrate | 3.92 | kg |
| 1N KOH | 1.08 | kg |
| Potassium Hydroxide | 54.0 | g |
| Ascorbic Acid | 497.1 | g |
| ARASCO Mortierella alpina Oil | 359.5 | g |
| Soy Lecithin | 309.0 | g |
| Distilled Monoglycerides | 309.0 | g |
| Nucleotide-Choline Premix | 306.4 | g |
| Choline Bitartrate | 54.1 | g |
| Cytidine 5′-Monophosphate | 31.9 | g |
| Disodium Guanosine 5′-Monophosphate | 16.3 | g |
| Disodium Uridine 5′-Monophosphate | 13.7 | g |
| Adenosine 5′-Monophosphate | 12.1 | g |
| Calcium Citrate | 303.6 | g |
| Ultra Micronized Tricalcium Phosphate | 152.3 | g |
| Carrageenan | 140.0 | g |
| Magnesium Chloride | 142.3 | g |
| DHASCO Crypthecodinium cohnii Oil | 136.9 | g |
| Potassium Chloride | 93.5 | g |
| Vit/Min/Taur Premix | 89.9 | g |
| Taurine | 27.5 | g |
| m-Inositol | 20.0 | g |
| Zinc Sulfate | 9.2 | g |
| Niacinamide | 5.9 | g |
| Calcium Pantothenate | 3.5 | g |
| Ferrous Sulfate | 3.1 | g |
| Cupric Sulfate | 1.1 | g |
| Thiamine Chloride HCl | 910.2 | mg |
| Riboflavin | 401.4 | mg |
| Pyridoxine HCl | 367.7 | mg |
| Folic Acid | 123.6 | mg |
| Manganese Sulfate | 104.7 | mg |
| Biotin | 35.5 | mg |
| Sodium Selenate | 21.3 | mg |
| Cyanocobalamin | 2.8 | mg |
| Carrageenan | 60.0 | g |
| Mixed Carotenoid Premix | 57.7 | g |
| Lycopene | 121.2 | mg |
| Lutein | 121.2 | mg |
| Beta-Carotene | 26.3 | mg |
| Ferrous Sulfate | 35.3 | g |
| Vitamin A, D3, E, K1 | 33.1 | g |
| RRR Alpha-Tocopheryl Acetate | 6.69 | g |
| Vitamin A Palmitate | 1.26 | g |
| Vitamin K1 (Phylloquinone) | 72.8 | mg |
| Vitamin D3 | 8.8 | mg |
| Choline Chloride | 32.4 | g |
| Calcium HMB | 32.0 | g |
| L-Carnitine | 2.31 | g |
| Potassium Citrate | 1.86 | g |
| Riboflavin | 838 | mg |
| Vitamin A | 540 | mg |
| Thiamine Hydrochloride | 135 | mg |
| Sodium Chloride | as needed | |

Example 4, which is found in Table VI, is a ready-to-feed liquid term infant formula that is useful for feeding a newborn from 0 to 365 days of life. The infant formula has a caloric density of 643 kcal/L and contains 2 mg of HMB per liter of formula.

TABLE VI

| | Amount per 1000 Kg of | |
|---|---|---|
| | Ready to Feed Liquid | |
| Ingredient Name | Formula | Units |
| Ingredient Water | Q.S. | Kg |
| Cond. Skim Milk | 83.00 | Kg |
| Lactose | 51.50 | Kg |
| High Oleic Safflower Oil | 12.93 | Kg |
| Soy Oil | 10.39 | Kg |
| Coconut Oil | 9.160 | Kg |
| Galacto-oligosaccharides | 8.630 | Kg |
| Whey Protein Concentrate | 6.075 | Kg |
| 1N KOH | 4.060 | Kg |
| Potassium Hydroxide | 203.0 | g |
| Ascorbic Acid | 727.5 | g |
| Calcium Carbonate | 449.9 | g |
| Potassium Citrate | 536.6 | g |
| Soy Lecithin | 508.4 | g |
| Myverol 18-06 | 508.4 | g |
| ARASCO Mortierella Alpina Oil | 359.3 | g |
| Nucleotide-Choline Premix | 293.2 | g |
| Choline Bitartrate | 51.75 | g |
| Cytidine 5′-Monophosphate | 30.49 | g |
| Disodium Guanosine 5′-Monophosphate | 15.64 | g |
| Disodium Uridine 5′-Monophosphate | 13.15 | g |
| Adenosine 5′-Monophosphate | 11.60 | g |
| Potassium Chloride | 199.9 | g |
| Carrageenan | 175.0 | g |
| Magnesium Chloride | 154.0 | g |
| Vit/Min/Taur Premix | 149.9 | g |
| Taurine | 45.83 | g |
| m-Inositol | 33.28 | g |
| Zinc Sulfate | 15.35 | g |
| Niacinamide | 9.781 | g |
| Calcium Pantothenate | 5.865 | g |
| Ferrous Sulfate | 5.131 | g |
| Cupric Sulfate | 1.800 | g |
| Thiamine Chloride HCl | 1.518 | g |
| Riboflavin | 669.3 | mg |
| Pyridoxine HCl | 613.1 | mg |
| Folic Acid | 206.1 | mg |
| Manganese Sulfate | 174.6 | mg |
| Biotin | 59.21 | mg |
| Sodium Selenate | 35.51 | mg |
| Cyanocobalamin | 4.722 | mg |
| DHASCO Crypthecodinium Cohnii Oil | 131.0 | g |
| Ultra-Micronized Tricalcium Phosphate | 103.2 | g |
| Potassium Phosphate Monobasic | 90.6 | g |
| Vitamin A, D3, E, K1 | 69.4 | g |
| RRR Alpha-Tocopheryl Acetate | 8.986 | g |
| Vitamin A Palmitate | 1.783 | g |
| Vitamin K1 (Phylloquinone) | 99.50 | mg |
| Vitamin D3 | 13.87 | mg |
| Choline Chloride | 65.4 | g |
| Ferrous Sulfate | 60.9 | g |
| Carotenoid Premix | 57.1 | g |
| Lutein | 119.9 | mg |
| Lycopene | 119.9 | mg |
| Beta-Carotene | 25.98 | mg |
| Sodium Chloride | 40.1 | g |
| Citric Acid (Processing Aid) | 29.8 | g |
| L-Carnitine | 3.62 | g |
| Calcium HMB | 2.50 | g |
| Riboflavin | 1.17 | g |

Example 5, which is found in Table VII is a powder infant formula that is useful for feeding a newborn from 0 to 365 days of life. The powder formula is reconstituted so that it has a caloric density of 643 kcal/L and 2 mg of HMB per liter.

TABLE VII

| | Amount per 1000 Kg | |
|---|---|---|
| Ingredient Name | of Powder Formula | Units |
| Nonfat Milk | 692.9 | kg |
| Lactose | 385.7 | kg |
| High Oleic Safflower Oil | 115.5 | kg |
| Soy Oil | 87.65 | kg |
| Coconut Oil | 80.00 | kg |
| Galacto-oligosaccharides | 70.50 | kg |
| Whey Protein Concentrate | 52.02 | kg |
| Potassium Citrate | 10.95 | kg |
| Calcium Carbonate | 3.55 | kg |
| ARASCO Mortierella alpina Oil | 2.91 | kg |
| Nucleotide-Choline Premix | 2.51 | kg |
| Choline Bitartrate | 443.7 | g |
| Cytidine 5′-Monophosphate | 261.5 | g |
| Disodium Guanosine 5′-Monophosphate | 134.1 | g |
| Disodium Uridine 5′-Monosphosphate | 112.8 | g |
| Adenosine 5′-Monophosphate | 99.4 | g |
| Sodium Chloride | 1.48 | kg |
| Ascorbic Acid | 1.34 | kg |
| Tricalcium Phosphate | 1.25 | kg |
| Vit/Min/Taur Premix | 1.17 | kg |
| Taurine | 357.5 | g |
| m-Inositol | 259.5 | g |
| Zinc Sulfate | 119.7 | g |
| Niacinamide | 76.3 | g |
| Calcium Pantothenate | 45.7 | g |
| Ferrous Sulfate | 40.0 | g |
| Cupric Sulfate | 14.0 | g |
| Thiamine Chloride HCl | 11.8 | g |
| Riboflavin | 5.22 | g |
| Pyridoxine HCl | 4.78 | g |
| Folic Acid | 1.61 | g |
| Manganese Sulfate | 1.36 | g |
| Biotin | 462 | mg |
| Sodium Selenate | 277 | mg |
| Cyanocobalamin | 36.8 | mg |
| Soy Lecithin | 1.12 | kg |
| Magnesium Chloride | 1.10 | kg |
| Potassium Phosphate Monobasic | 1.09 | |
| DHASCO Crypthecodinium cohnii Oil | 1.09 | kg |
| Ascorbyl Palmitate | 547.6 | g |
| Vitamin A, D3, E, K1 | 543.0 | g |
| RRR Alpha-Tocopheryl Acetate | 76.1 | g |
| Vitamin A Palmitate | 14.5 | g |
| Vitamin K1 (Phylloquinone) | 841.7 | mg |
| Vitamin D3 | 112.3 | mg |
| Ferrous Sulfate | 494.9 | g |
| Carotenoid Premix | 475.1 | g |
| Lutein | 997.7 | mg |
| Lycopene | 997.7 | mg |
| Beta-Carotene | 216.2 | mg |
| Choline Chloride | 452.6 | g |
| Mixed Tocopherols (Tenox GT-2—70%) | 241.8 | g |
| Mixed Tocopherols | 169.3 | g |
| Potassium Chloride | 207.0 | g |
| L-Carnitine | 27.6 | g |
| Calcium HMB | 20.4 | g |
| Riboflavin | 3.33 | g |
| Potassium Hydroxide (processing aid) | as needed | |

### Experimental Study

A study of neonatal piglets is performed in order to measure the extent by which HMB affects muscle protein synthesis. The neonatal piglet model was used because of the similarity in its development to that of the human term infant and because of the piglet's rapid rate of growth.

### Experimental Methods

Overnight fasted neonatal pigs (5-7 days old) were infused with HMB with 0, 20, 100, or 400 μmol·kg⁻¹·hr⁻¹ HMB. Blood plasma concentrations of the following circulating substrates were measured. HMB was measured using gas chromatography per the method set forth in: Nissen, Steven (1990). Analysis of β-Hydroxy-β-methyl Butyrate in Plasma by Gas Exclusion Chromatography and Mass Spectrometry Analytical Biochemistry 188, 17-19.

Amino acids including leucine, other branched-chain amino acids (BCAA), essential amino acids (EAA) and nonessential amino acids (NEAA) were determined using high pressure liquid chromatography using the method set forth in: Davis TA(1993). Enhanced response of muscle protein synthesis and plasma insulin to food intake in suckled rats. Am J Physiol Regul Integr Comp Physiol 265:R334-R340.

Alpha-keto acids of branched chain amino acids (i.e., a-ketoisocaproic acid (KIC, the α-keto acid of leucine), α-ketoisovalerate (KIV, the α-keto acid of valine) and α-ketomethylvalerate (KMV, the α-keto acid of isoleucine)) were measured by high pressure liquid chromatography using the method set forth in: Nissen, S. L. (1982). Measurement of branched chain amino acids and branched chain alpha-ketoacids in plasma by high performance liquid chromatography. J Chromatog 232, 170-175.

At the end of the infusion, the piglets were sacrificed and the fractional protein synthesis rates were measured by measuring ³H incorporation into protein fractions after a flooding dose of L[4-³H]phenylalanine using the method set forth in Garlick P. J. (1980). A rapid and convenient technique for measuring the rate of protein synthesis in tissues by injection of [3H]Phenylalanine Biochem J 192:719-723. Activation of translation initiation was measured in the stomach, duodenum, jejunum, colon, pancreas, kidney, brain and skin. The abundance of intracellular proteins involved in signaling of protein synthesis and in processes related to protein degradation was measured in tissue homogenates by immunoblotting using commercially available antibodies.

### Data

The data collected using the experimental methods were analyzed by ANOVA for a Completely Randomized Design. When a significant treatment effect was detected, means were compared using the post-hoc Fisher LSD test. Data are presented as least square means ±SEM and differences were considered significant at P≦0.10.

1. Circulating substrates:

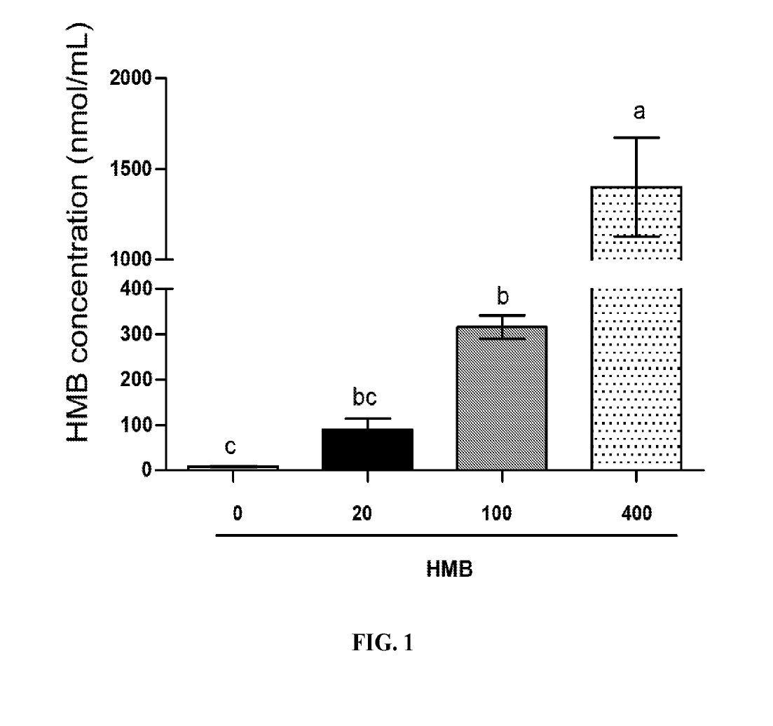

FIG. 1 shows a plot of the blood plasma concentration of HMB vs. the amount of HMB that was infused. Values are presented as means +/−SEM; n=6-7 per treatment. Values not sharing superscripts differ significantly (P<0.5).

As can be seen in FIG. 1, plasma concentrations of HMB achieved were 9, 90, 316, and 1400 nmol·ml⁻¹ in piglets respectively infused with 0, 20, 100, or 400 μmol·kg⁻¹·hr⁻¹ HMB. The plasma concentration of HMB was significantly greater in the piglets infused with 100 and 400 μmol·kg⁻¹hr⁻¹ HMB as compared to the HMB baseline group (i.e., those piglets infused with 0 μmol·kg⁻¹hr⁻¹ HMB).

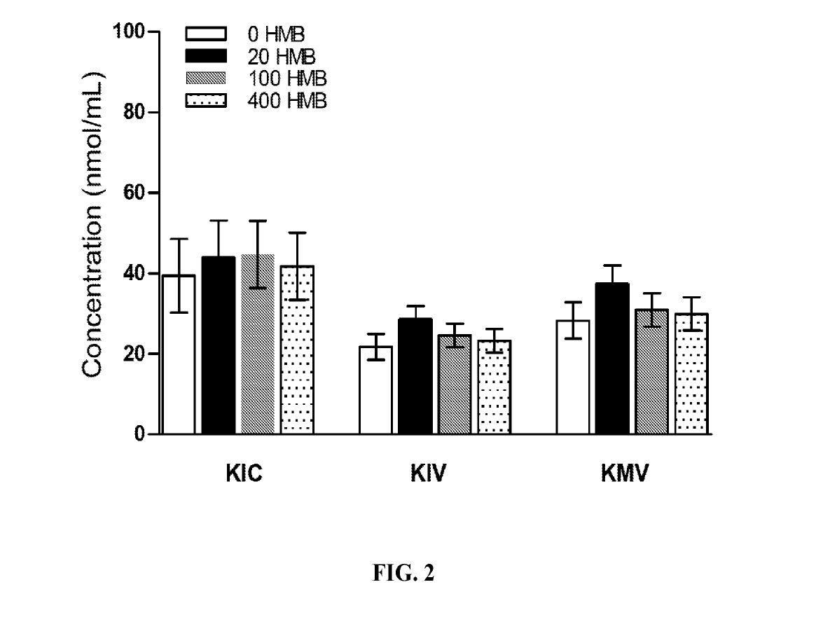

FIG. 2 shows a plot of the of plasma concentration (nmol/mL) of α-ketoisocaproic acid (KIC, the a-keto acid of leucine), α-ketoisovalerate (KIV, the α-keto acid of valine) and α-ketomethylvalerate (KMV, the α-keto acid of isoleucine) in piglets infused with 0, 20, 100 or 400 μmol·kg⁻¹·hour⁻¹ HMB. Values are means +/−SEM; n=6-7 per treatment. Values within each plasma α-keto acid grouping not sharing superscripts differ significantly (P<0.05).

As can be seen in FIG. 2, the infusion of HMB had no impact on the circulating concentrations of KIC, KIV and KMV.

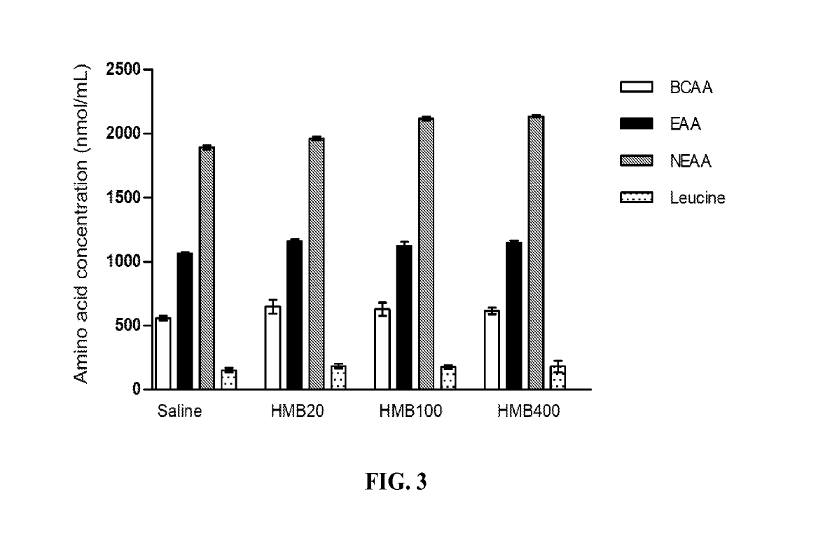

FIG. 3 shows a plot of plasma BCAA, EAA, NEAA and leucine concentrations (nmol amino acid per mL of plasma) in piglets infused with 0, 20, 100 or 400 μmol·kg⁻¹·hour⁻¹ HMB or 400 μmol·kg⁻¹·hour⁻¹ leucine for one hour. The values are means +/−SEM; n=6-7 per treatment. Values within each amino acid grouping not sharing superscripts differ significantly (P<0.05).

As can be seen in FIG. 3, the circulating concentration of HMB had no effect on the concentrations of leucine, BCAA, EAA or NEAA.

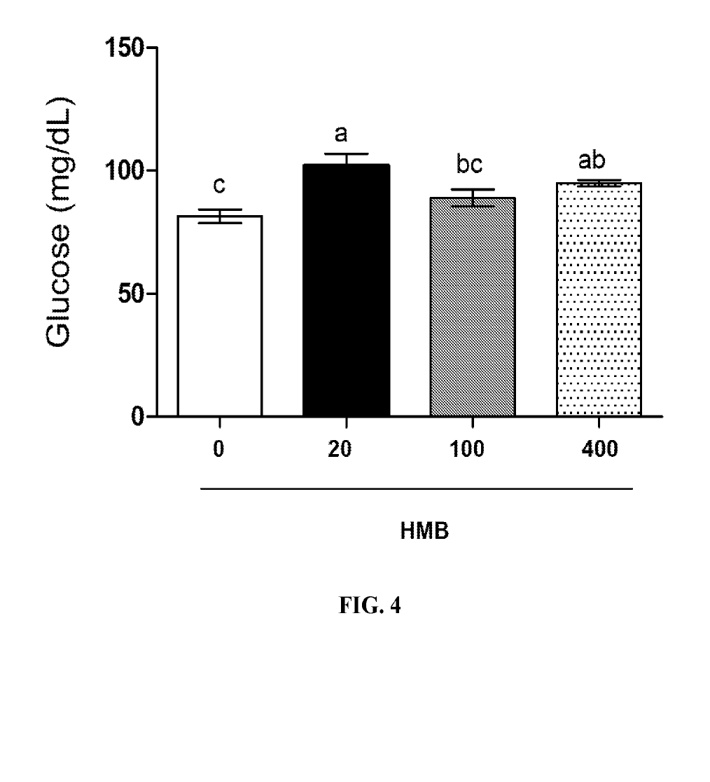

FIG. 4 shows a plot of plasma glucose concentrations in piglets infused with 0, 20, 100 or 400 μmol·kg⁻¹·hour⁻¹ HMB for one hour. Values are means +/−SEM; n=6-7 per treatment. Values for each HMB dosage not sharing superscripts differ significantly (P<0.05).

As shown in FIG. 4, the plasma glucose concentrations were modestly, but significantly (P<0.5), increased by infusion of 20 and 400 μmol·kg⁻¹·hour⁻¹ HMB for one hour.

2. Protein Synthesis:

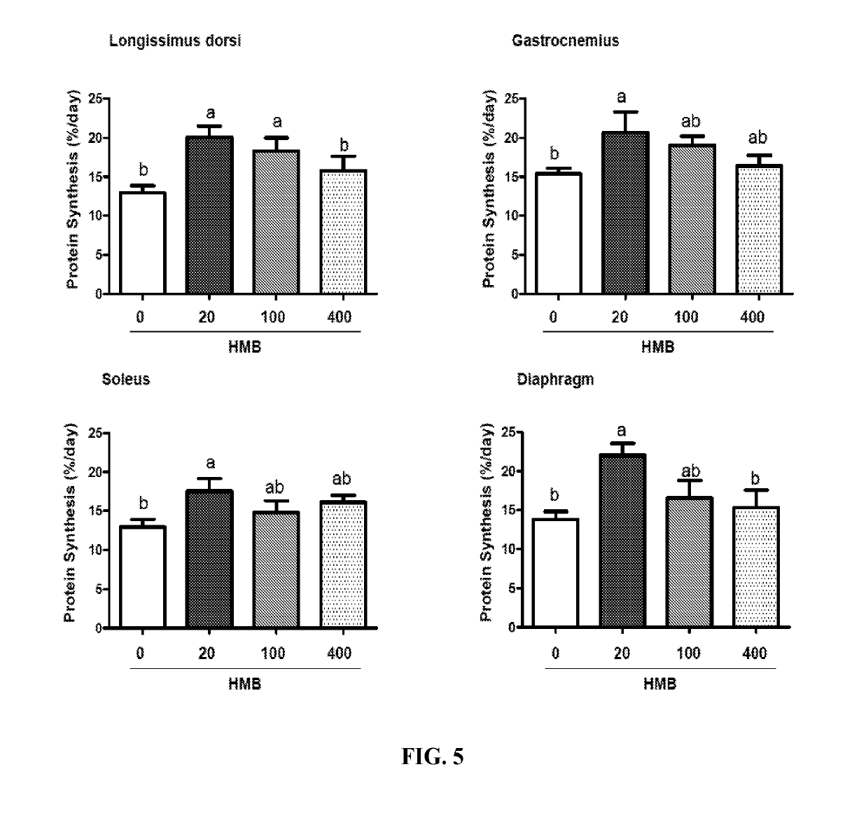

FIG. 5 shows a plot of the fractional rate of protein synthesis in skeletal muscles, specifically the longissimus dorsi, gastrocnemius, soleus and diaphragm, of piglets infused with 0, 20, 100 or 400 μmol·kg⁻¹·hour⁻¹ HMB for one hour. Values are means +/−SEM; n=6-7 per treatment. Values within HMB infusion grouping not sharing superscripts differ significantly (P<0 .05).

As can be seen in FIG. 5, infusion of 20 μmol·kg⁻¹·hour⁻¹ HMB increased (P<0.05) the fractional rates of protein synthesis in the skeletal muscles, specifically, the longissimus dorsi muscle, gastrocnemius, soleus and diaphragm. Infusion of 100 μmol·kg⁻¹·hour⁻¹ HMB increased (P<0.05) protein synthesis in the longissimus dorsi muscle, but not significantly in the gastrocnemius, soleus and diaphragm muscles. Infusion of 400 μmol·kg⁻¹·hour⁻¹ HMB had no significant effect on proteins synthesis in the skeletal muscles.

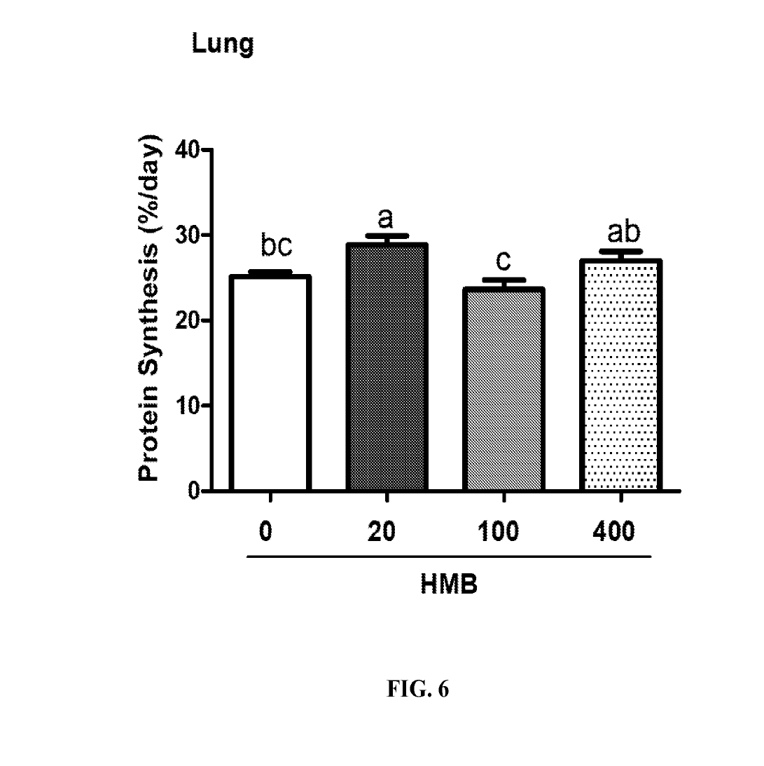

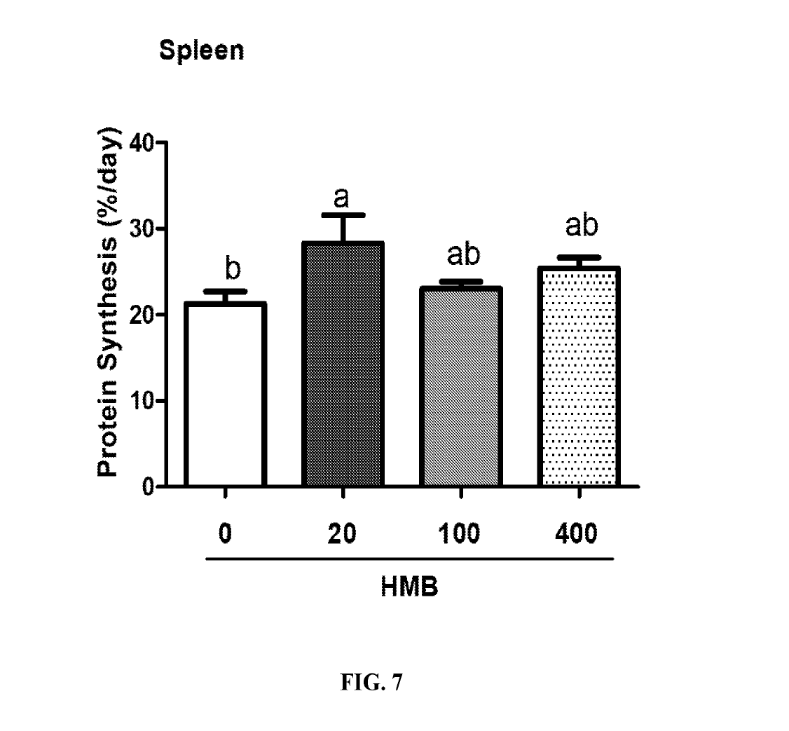

FIGS. 6 and 7 show plots of the fractional rate of protein synthesis in the lung and spleen of piglets infused with 0, 20, 100 or 400 μmol·kg⁻¹·hour⁻¹ HMB for one hour. Values are means +/−SEM; n=6-7 per treatment. Values within HMB infusion grouping not sharing superscripts differ significantly (P<0.05).

As shown in FIGS. 6 and 7, infusion of 20, 100 or 400 μmol·kg⁻¹·hour⁻¹ HMB for one hour increase protein synthesis in the lung and spleen at the infusion rate of 20 μmol·kg⁻¹·hour⁻¹ HMB.

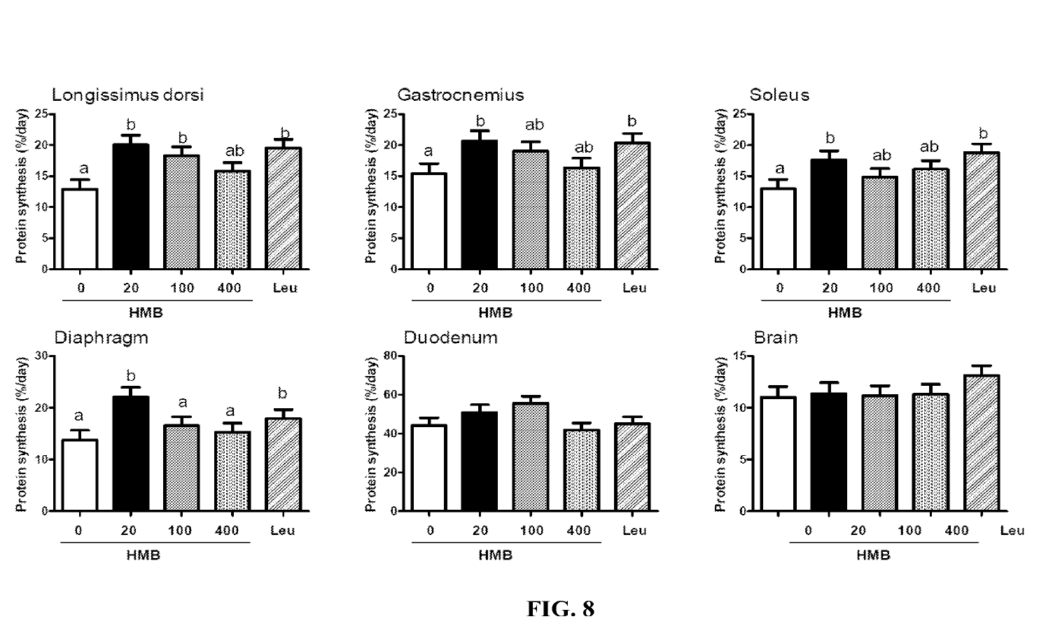

FIG. 8 shows a comparison of protein synthesis rates in the longissimus dorsi, gastrocnemius, soleus, diaphragm, duodenum and brain of piglets that were infused with HMB given at a rate of 0, 20, 100 or 400 μmol kg⁻¹ h⁻¹ and leucine at a rate of 400 μmol·kg⁻¹·hour⁻¹

As shown in FIG. 8, it was surprisingly found that the infusion of HMB was equal to or more effective in increasing protein synthesis than leucine.

3. Intracellular Signaling Components:

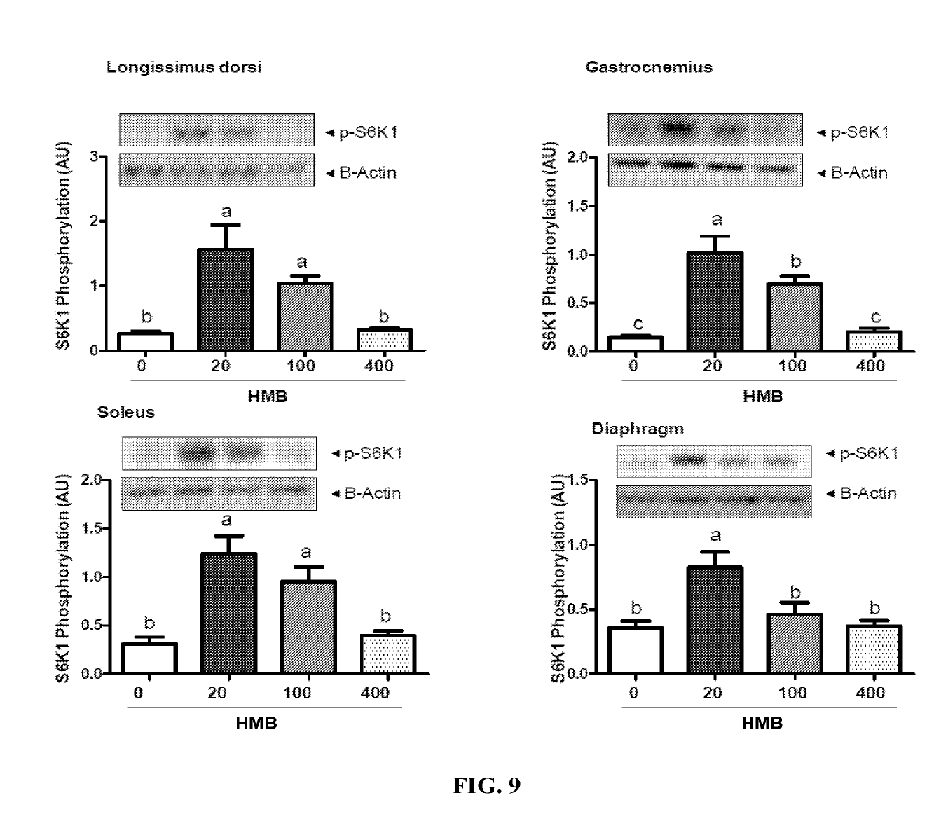

FIG. 9 shows a plot of the phosphorylation of S6K1 in the longissimus dorsi, gastrocnemius, soleus and diaphragm of piglets infused with 0, 20, 100 or 400 μmol·kg⁻¹·hour⁻¹ HMB for one hour. The phosphorylation of S6K1 is an indicator of mTORC1 signaling to translation.

As shown in FIG. 9, infusion of 20 and 100 μmol·kg⁻¹·hour⁻¹ HMB for one hour increased the phosphorylation of S6K1 in the longissimus dorsi, gastrocnemius and soleus. Infusion of 20, but not 100, μmol·kg⁻¹·hour⁻¹ HMB for one hour increased phosphorylation of S6K1 in the diaphragm. Values are means +/−SEM; n=6-7 per treatment. Values within HMB infusion grouping not sharing superscripts (a,b) differ significantly (P<0.05) for the longissimus dorsi and (P<0.10) for other tissues.

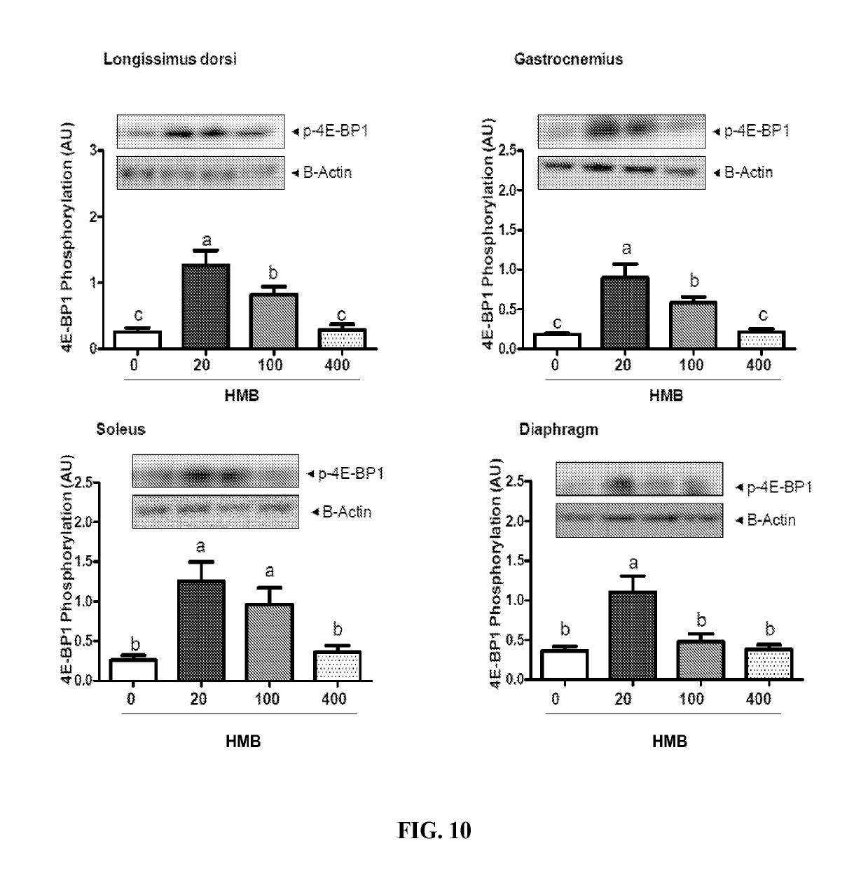

FIG. 10 shows a plot of the phosphorylation of 4EBP1 in the longissimus dorsi, gastrocnemius, soleus and diaphragm of piglets infused with 0, 20, 100 or 400 μmol·kg⁻¹·hour⁻¹ HMB for one hour. The phosphorylation of 4EBP1 is an indicator of mTORC1 signaling to translation.

As shown in FIG. 10, infusion of 20 and 100 μmol·kg⁻¹·hour⁻¹ HMB for one hour increased the phosphorylation of 4EBP1 in the longissimus dorsi, gastrocnemius and soleus. Infusion of 20, but not 100, μmol·kg⁻¹·hour⁻¹ HMB for one hour increased phosphorylation of 4EBP 1 in the diaphragm.

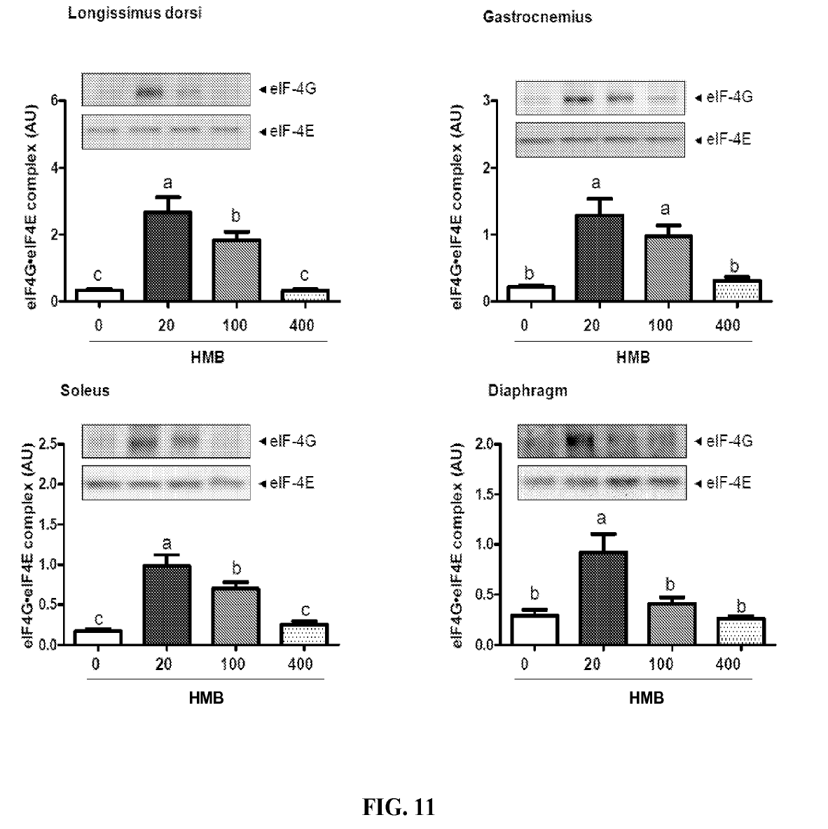

FIG. 11 shows a plot of the formation of the active elF4E·elF4G complex in the longissimus dorsi, gastrocnemius, soleus and diaphragm of piglets infused with 0, 20, 100 or 400 μmol·kg⁻¹·hour⁻¹ HMB for one hour. The formation of the active elF4E·elF4G complex is an indicator of mTORC1 signaling to translation.

As shown in FIG. 11, infusion of 20 and 100 μmol·kg⁻¹·hour⁻¹ HMB for one hour increased the phosphorylation of 4EBP1 in the longissimus dorsi, gastrocnemius and soleus. Infusion of 20, but not 100, μmol·kg⁻¹·hour⁻¹ HMB for one hour increased phosphorylation of 4EBP 1 in the diaphragm.

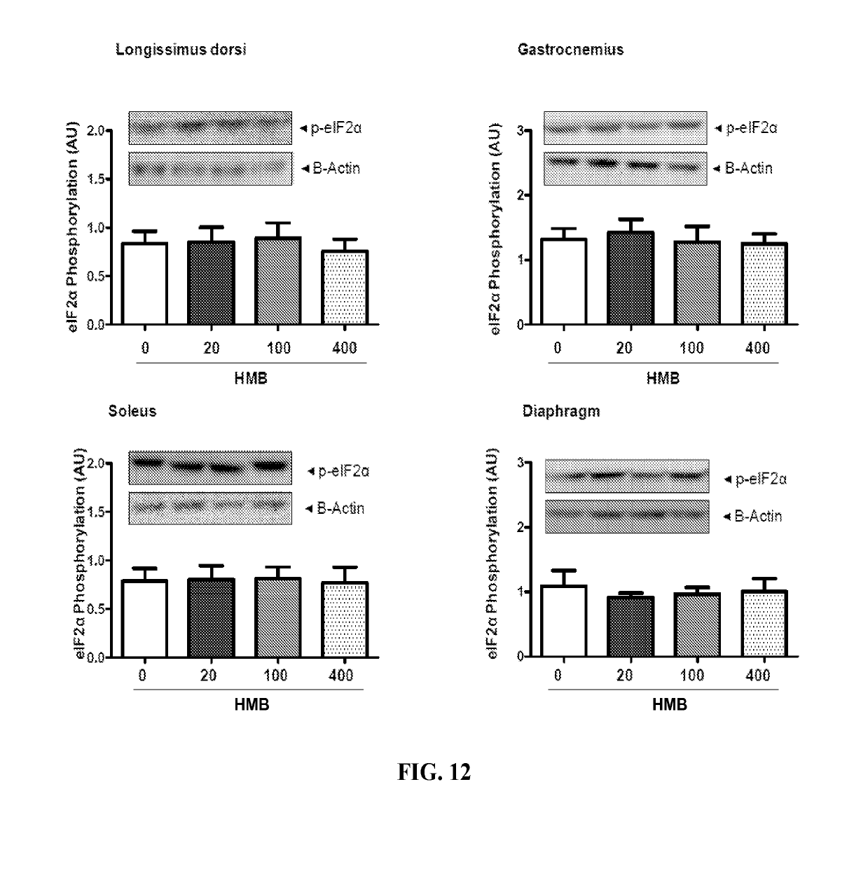

FIG. 12 shows a plot of the phosphorylation of elF2α in the longissimus dorsi, gastrocnemius, soleus and diaphragm of piglets infused with 0, 20, 100 or 400 μmol·kg⁻¹·hour⁻¹ HMB for one hour. The formation of phosphorylation of elF2α regulates tRNA-ribosome binding.

As shown in FIG. 12, infusion of 20 and 100 μmol·kg⁻¹·hour⁻¹ HMB for one hour did not affect the phosphorylation of elF2α.

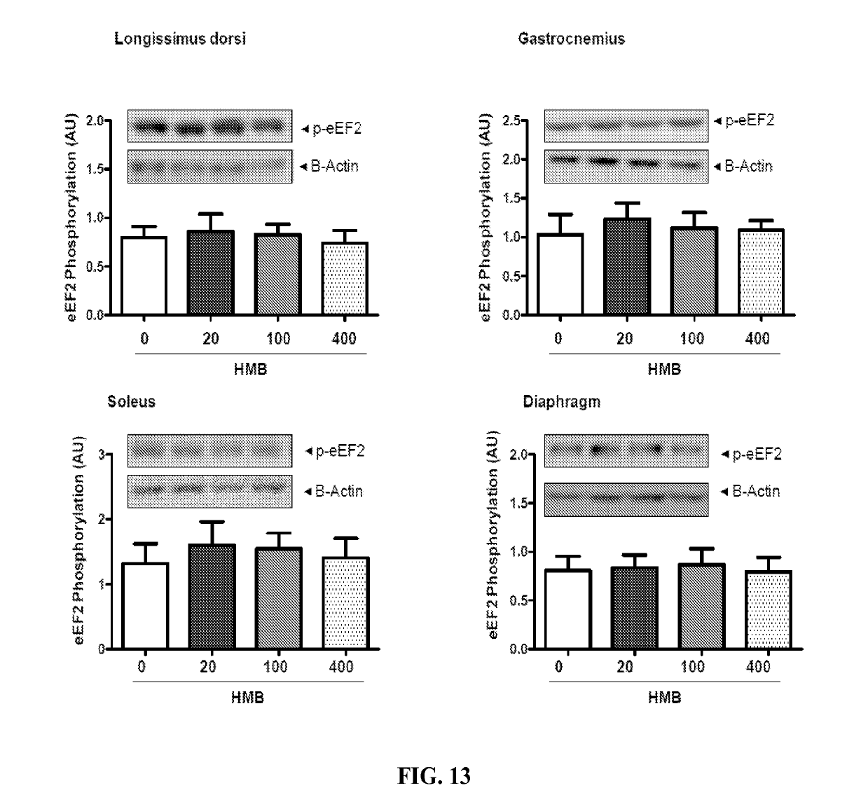

FIG. 13 shows a plot of the phosphorylation of eEF2 in the longissimus dorsi, gastrocnemius, soleus and diaphragm of piglets infused with 0, 20, 100 or 400 μmol·kg⁻¹·hour⁻¹ HMB for one hour. The formation of phosphorylation of eEF2 regulates tRNA-ribosome binding.

As shown in FIG. 13, infusion of 20 and 100 μmol·kg⁻¹·hour⁻¹ HMB for one hour did not affect the phosphorylation of eEF2.

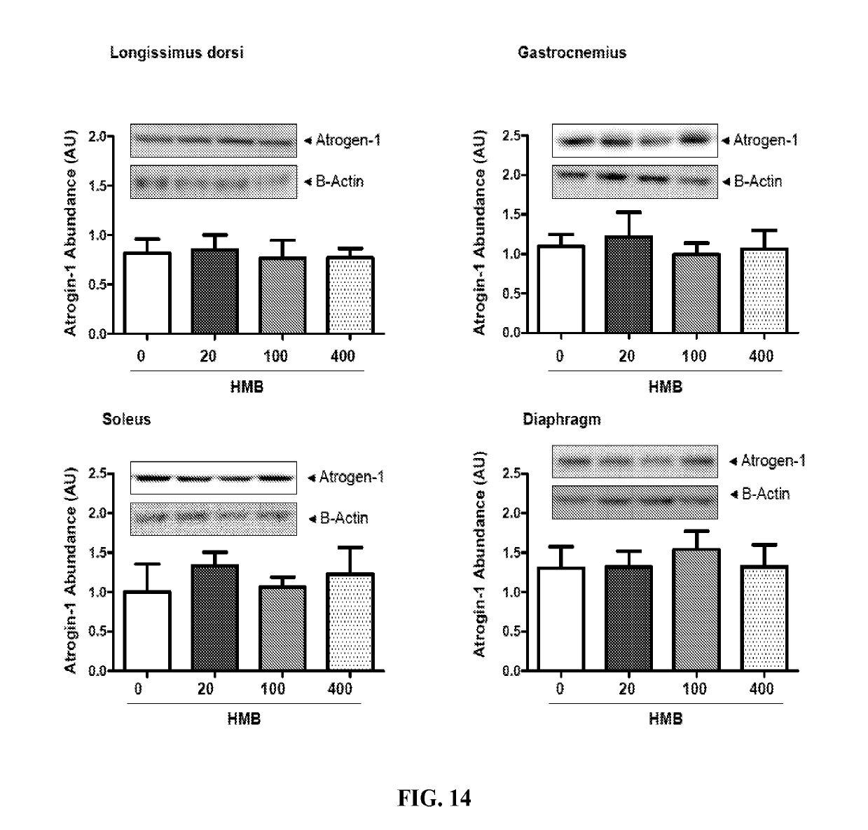

FIG. 14 shows a plot of the expression of Atrogin-1 in the longissimus dorsi, gastrocnemius, soleus and diaphragm of piglets infused with 0, 20, 100 or 400 μmol·kg⁻¹·hour⁻¹ HMB for one hour. Atrogin-1 is a muscle-specific ubiquitin ligase.

As shown in FIG. 14, infusion of 20 and 100 μmol·kg⁻¹·hour⁻¹ HMB for one hour did not affect the expression of Atrogin-1.

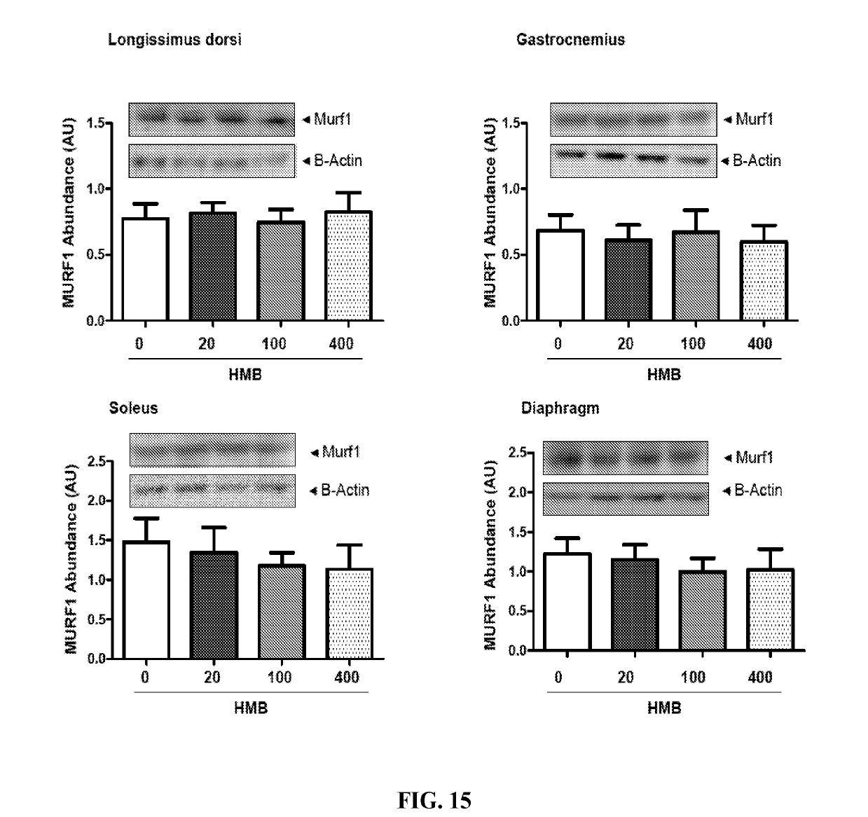

FIG. 15 shows a plot of the expression of MURF1 in the longissimus dorsi, gastrocnemius, soleus and diaphragm of piglets infused with 0, 20, 100 or 400 μmol·kg⁻¹·hour⁻¹ HMB for one hour. MURF1 is a muscle-specific ubiquitin ligase.

As shown in FIG. 15, infusion of 20 and 100 μmol·kg⁻¹·hour⁻¹ HMB for one hour did not affect the expression of Atrogin-1.

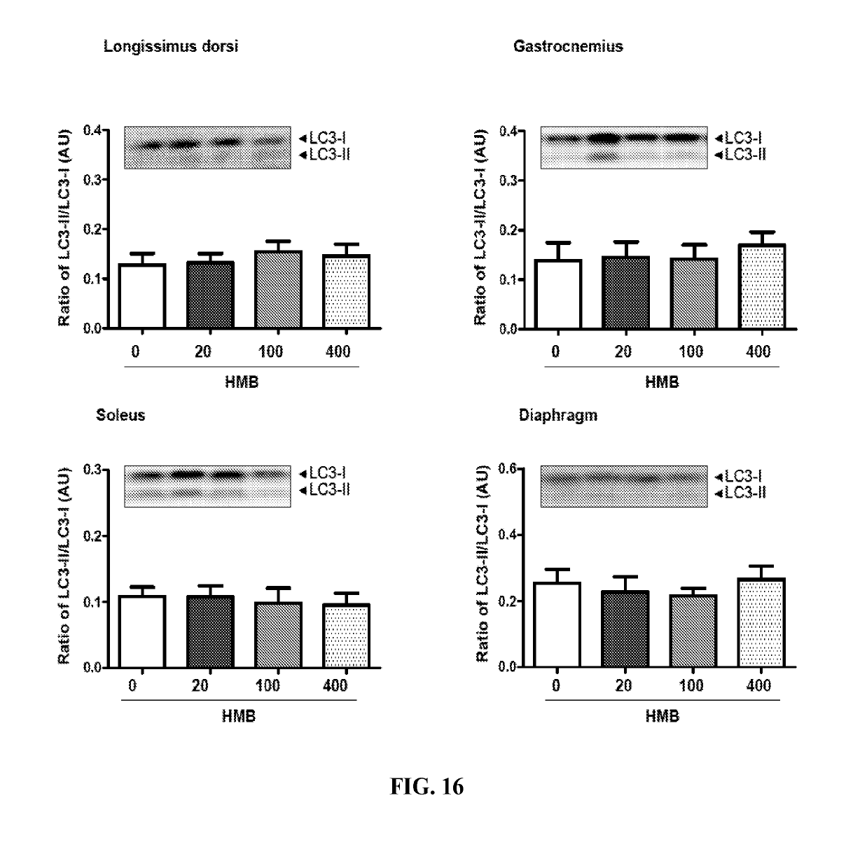

FIG. 16 shows a plot of the ratio of LC3-II/LC3-I in the longissimus dorsi, gastrocnemius, soleus and diaphragm of piglets infused with 0, 20, 100 or 400 μmol·kg⁻¹·hour⁻¹ HMB for one hour. The ratio of LC3-II/LC3-I is an indicator of autophagy/lysosomal protein degradation.

As shown in FIG. 16, infusion of 20 and 100 μmol·kg⁻¹·hour⁻¹ HMB for one hour did not affect the ratio of LC 3 -II/LC 3 -I.

### Analysis

These data demonstrate that HMB activated protein synthesis by inducing mTORC1. Unexpectedly, HMB did not affect markers of protein degradation or the level of amino acid transporters. The observation that HMB did not affect markers of protein degradation is important because nutritional products for term infants should not interfere with protein degradation, which is required for normal development of all tissues. These data are particularly surprising given that it is well established that HMB attenuates protein degradation in the muscles of adults. See for example: Smith, Helen J. (2004). Mechanism of the Attenuation of Proteolysis-Inducing Factor Stimulated Protein Degradation in Muscle by β-Hydroxy-β-Methylbutyrate. Cancer Research, 64, 8731-8735; and Smith, Helen J (2005). Attenuation of Proteasome-Induced Proteolysis in Skeletal Muscle by β-Hydroxy-P-Methylbutyrate in Cancer-Induced Muscle Loss. Cancer Research, 65, 277-283. Thus the present discovery is highly unexpected.

Furthermore, the data surprisingly show that the effect of HMB on protein synthesis was not proportional to the level of HMB intake. For example, the lowest dose of HMB 20 μmol kg⁻¹ h⁻¹, had the greatest impact on protein synthesis, whereas the highest dose, 400 μmol kg⁻¹ h⁻¹ had the least impact on protein synthesis in 4 muscles that represent fast twitch, slow twitch, voluntary and involuntary muscle types. Therefore, there is a discrete range of HMB intake that promotes protein synthesis in neonates.

Additionally, the data surprisingly show that HMB is as effective as leucine in promoting protein synthesis in neonates.

The values for the amounts of ingredients in the infant formulas set forth in the claims are on an as-fed basis.

1. An infant formula comprising beta-hydroxy-beta-methylbutyric acid at from about 60 μg to about 6,000 mg per liter of the formula and a macronutrient, the formula having an energy density of from about 200 kcal to about 650 kcal per liter.

2. The infant formula according to claim 1, wherein the formula is a liquid.

3. The infant formula according to claim 1, wherein the beta-hydroxy-beta-methylbutyric acid is in a form selected from: free acid; salt; anhydrous salt; ester; lactone; and mixtures thereof.

4. The infant formula according to claim 3, wherein the beta-hydroxy-beta-methylbutyric acid is a beta-hydroxy-beta-methylbutyric salt selected from: sodium salt; potassium salt; magnesium salt; chromium salt; calcium salt; and mixtures thereof.

5. The infant formula according to claim 1, comprising protein in an amount of from about 0.5 grams to about 14 grams protein per liter of formula.

6. The infant formula according to claim 1, comprising protein in an amount from about 5 grams to about 10 grams protein per liter of formula.

7. The infant formula according to claim 1, comprising protein in an amount from about 7.6 grams to about 10 grams protein per liter of formula.

8. The infant formula of claim 1, comprising beta-hydroxy-beta-methylbutyric acid at less than 1,500 mg per liter of the formula.

9. The infant formula of claim 1, comprising beta-hydroxy-beta-methylbutyric acid at less than 300 mg per liter of the formula.

10. A method for promoting protein synthesis in a term infant, the method comprising the step of administering to the infant a liquid infant formula comprising beta-hydroxy-beta-methylbutyric acid at from about 60 μg to about 6000 mg per liter of the formula, the formula having an energy density of from about 200 kcal to about 650 kcal per liter.

11. The method of claim 10, further comprising the step of preparing the liquid infant formula by reconstituting a nutritional powder comprising beta-hydroxy-beta-methylbutyric acid.

12. The method of claim 11, wherein the concentration of the beta-hydroxy-beta-methylbutyric acid in the nutritional powder is less than or equal to about 15% by weight of the powder.

13. The method of claim 12, wherein the concentration of the beta-hydroxy-beta-methylbutyric acid in the powder is from about 0.0001% to about 10% by weight of the powder.

14. The method of claim 10, wherein the liquid infant formula comprises at least one macronutrient selected from the group consisting of protein, carbohydrate, fat and combinations thereof.

15. The method of claim 14, wherein the formula comprises protein in an amount of from about 0.5 grams to about 14 grams protein per liter of formula.

16. The method of claim 14, wherein the formula comprises protein in an amount from about 5 grams to about 10 grams protein per liter of formula.

17. The method of claim 10, wherein the liquid infant formula is administered to the subject orally or parenterally.
